(19) United States
(12) Patent Application Publication
(10) Pub. No.: US 2021/0143931 A1
(43) Pub. Date: May 13, 2021

(54) METHODS, APPARATUSES, AND COMPUTER PROGRAMS FOR LINK ADAPTATION

(71) Applicant: Telefonaktiebolaget LM Ericsson (publ), Stockholm (SE)

(72) Inventors: David SANDBERG, Sundbyberg (SE); Torbjörn WIGREN, Uppsala (SE)

(73) Assignee: Telefonaktiebolaget LM Ericsson (publ), Stockholm (SE)

(21) Appl. No.: 16/622,628

(22) PCT Filed: Jun. 16, 2017
(86) PCT No.: PCT/SE2017/050649

§ 371 Date: Dec. 13, 2019

(51) Int. Cl. H04L 1/00; H04L 25/02

(52) U.S. Cl. CPC H04L 1/0015; H04L 1/0009; H04L 1/0003; H04L 25/0202

(57) ABSTRACT

Apparatus and methods for link adaptation for downlink transmissions in which the quality of the downlink radio channel is predicted with improved accuracy. For example, predicted channel gains are determined based on uplink transmissions on a per frequency sub-band basis and these predicated channel gains are then used in a link adaptation process for a downlink transmission.

### TECHNICAL FIELD

Disclosed are embodiments for link adaptation.

### BACKGROUND

Link adaptation is a term used in radio communications. Link adaptation is the ability to adapt transmission parameters (e.g., modulation and coding scheme (MCS)) according to the quality a radio channel between a transmitter and a receiver (e.g., according to the estimated gain of the radio channel). For example, if the conditions of the radio channel are good, a small amount of error correction is used as this gives a high data throughput on the radio channel. If the conditions of the radio channel are poor, however, then a robust, modulation and coding scheme is used and the amount of error correction is increased, but the data throughput will drop considerably. As is readily apparent, it is important to accurately gauge the quality of the radio channel because, for example, if the transmitter incorrectly determines that the radio channel quality is poor when it in fact is not poor, then the transmitter will use inefficient transmission parameters (e.g., the error correction scheme will be too robust). Similarly, if the transmitter incorrectly determines that the radio channel quality is good when it in fact is poor, then the transmitter may not employ a robust enough MCS, which can lead to the need for several retransmissions of the data until it is successfully received at the receiver.

### SUMMARY

This disclosure describes system and methods for link adaptation for downlink transmissions in which the quality of the downlink radio channel is predicted with improved accuracy. For example, predicted channel gains are determined based on uplink transmissions on a per frequency sub-band basis and these predicated channel gains are then used in a link adaptation process for a downlink transmission (i.e., the predicted channel gains are used in a process that selects transmission parameters, such as the MCS, for the downlink transmission).

Accordingly, in one aspect there is provided a method performed by a network node of a radio access network for link adaptation with respect to a channel between a wireless communication device (WCD) and the network node, wherein the channel is defined in continuous time and a sampling rate of the channel is non-uniform. The method includes: receiving: i) a first uplink (UL) transmission from the WCD on a first UL sub-band of the channel and ii) a second UL transmission from the WCD on a second UL sub-band of the channel, wherein the first and second UL transmissions are received at the same time; providing to a first channel predictor a first channel estimate based on the first UL transmission from the WCD on the first UL sub-band of the channel; providing to a second channel predictor a second channel estimate based on the second UL transmission from the WCD on the second UL sub-band of the channel; retrieving a first previous channel estimate; retrieving a second previous channel estimate; the first channel predictor using the first channel estimate and the first previous channel estimate to predict a first channel gain; the second channel predictor using the second channel estimate and the second previous channel estimate to predict a second channel gain; and using the first and second predicated channel gains, performing a link adaptation for downlink, DL, sub-bands corresponding to the first and second UL sub-bands.

In some embodiments, using the first channel estimate to predict the first channel gain comprises performing a first linear prediction in which a first continuous time estimated parameter vector is multiplied with a first regression vector obtained using a first sampling descriptor, k₁, and second sampling descriptor, k₂. Likewise, in some embodiments, using the second channel estimate to predict the second channel gain comprises performing a second linear prediction in which a second continuous time estimated parameter vector is multiplied with a second regression vector obtained using k₁ and k₂.

In some embodiments, the predicted first channel gain at time t, ŷ₁(t), is defined by: ŷ₁(t)=φ₁^{T}(t)\hat{θ}₁(t−k₂h)+c₁(t), wherein
φ₁^{T}(t) is a first regression vector at time t,
\hat{θ}₁(t−k₂h) is a channel estimate at a time taking k₂ into account, and
c₁(t) is a parameter independent part of the prediction.

In some embodiments, the predicted second channel gain at time t, ŷ₂(t), is defined by: ŷ₂(t)=φ₂^{T}(t)\hat{θ}₂(t−k₂h)+c₂(t), wherein
φ₂^{T}(t) is a second regression vector at time t,
\hat{θ}₂(t−k₂h) is a channel estimate at a time taking k₂ into account, and
c₂(t) is a parameter independent part of the prediction.

In another aspect, there is provided a network node for performing the above described method.

An advantage of the above described embodiment is that it provides significant capacity gains and can be implemented using low complexity software procedures.

### BRIEF DESCRIPTION OF THE DRAWINGS

The accompanying drawings, which are incorporated herein and form part of the specification, illustrate various embodiments.

FIG. 1 illustrates a wireless communication network.

FIG. 2 illustrates components of a network node according to some embodiments.

FIG. 3 is a flow chart illustrating a scheduling process according to some embodiments.

FIG. 4 is a graph comparing a baseline throughput to a predicted throughput.

FIG. 5 illustrates a channel quality filter according to some embodiments.

FIG. 6 shows a plurality of uplink transmissions by a wireless communication device over several sub-frames.

FIG. 7 is a flow chart illustrating a process according to some embodiments.

FIG. 8 is a flow chart illustrating a process according to some embodiments.

FIG. 9 is a block diagram of a network node according to some embodiments.

FIG. 10 is a diagram showing functional modules of a network node according to some embodiments.

### DETAILED DESCRIPTION

FIG. 1 illustrates a wireless communication network 100 according to an embodiment. The wireless communication network 100 may, for example, be a network such as a Long-Term Evolution (LTE) network or a 5G network or other network. Thus, although terminology from 3GPP LTE may be used in this disclosure to exemplify embodiments herein, this should not be seen as limiting the scope of the embodiments herein to only the aforementioned system.

In the wireless communication network 100, a wireless communication device (WCD) 102 communicates via a network node 112 (e.g., base station) of a radio access network (RAN) to one or more core networks (CNs) 110. It should be understood by the skilled in the art that “wireless communication device” is a non-limiting term which encompasses any wireless terminal, user equipment, Machine Type Communication (MTC) device, a Device to Device (D2D) terminal, or node e.g. Personal Digital Assistant (PDA), laptop, mobile phone, sensor, relay, mobile tablets or even a small base station communicating within respective cell.

Wireless communication network 100 covers a geographical area which is divided into cell areas, e.g. a cell 111 being served by network node 112. The network node 112 may be a radio base station e.g. a NodeB, an evolved Node B (eNB, eNode B), a base transceiver station, an Access Point Base Station, a base station router, a WI-FI access point, or any other network unit capable of communicating with a wireless device within the cell served by the radio network node depending e.g. on the radio access technology and terminology used. The network node 112 may serve one or more cells or areas, such as the cell 111.

The network node 112 communicates over a radio interface, also referred to as air interface, operating on radio frequencies with the WCD 102 within range of the network node 112. The WCD 102 transmits data over the radio interface to the radio network node 112 in uplink (UL) transmissions and the network node 112 transmits data over the radio interface to the WCD 102 in downlink (DL) transmissions.

Downlink Scheduling

This section describes a scheduling process performed by network node 112 for scheduling a DL transmission to WCD 102. With reference to FIG. 2, which shows components of network node 112, the scheduling process uses the following inputs: downlink buffer size, Channel Quality Indicator (CQI), Rank Indicator (RI), and Precoding Matrix Indicator (PMI). CQI, RI and PMI describe the channel state and are therefore often called Channel State Information. The outputs are: selected Physical Resource Blocks (PRBs), the Modulation and Coding Scheme (MCS), transmission rank, and precoder. Information identifying the selected PRBs, the MCS and the rank are transmitted to the UE in a downlink assignment command The precoder also needs to be sent to the UE if a transmission mode using cell specific reference symbols are used. For transmission modes using demodulation reference symbols the precoder is just applied to both the data and the reference symbols, and is therefore not explicitly required by the UE for demodulation.

The scheduling procedure is illustrated in FIG. 3. In step 302, downlink adapter 292 (see FIG. 2) initializes the allocation size to P PRBs, where P is an integer, typically 1. In step 304, downlink adapter 292 calculates an SINR for the current allocation based on the SINR per PRB given by the channel quality filtering unit 291 (see FIG. 2). In step 306, downlink adapter 292 determines the transport block size (TBS) and modulation and coding scheme (MCS) from the SINR. This determination may be based on a table lookup. The table is designed to give the TBS that gives 10% block error rate (BLER) for a given SINR. In step 308, downlink adapter 292 determines whether the determined TBS is larger or equal to the packet size (i.e. the estimated amount of data in the downlink buffer). If the determined TBS is larger or equal to the packet size, then the TBS, MCS and allocation size is stored and the loop is done. If not, the allocation size is increased (step 310) and another iteration in the loop is started at step 304.

This disclosure describes a low complexity process for data transmissions from network node 112 to WCD 102 that provides significant capacity gains. For example, a new baseband (BB) software (SW) process for data transmission is provided that shows capacity improvements up to 50%. The system impact is limited (e.g., only a BB SW augmentation) and the implementation complexity is low with memory requirements limited to about 10 states and about 50000 arithmetic operations per instance per second (maximum 1 instance per resource block—i.e., max of 100 instances). The potential gains are illustrated in FIG. 4, which is a graph showing a first line 402 that represents the baseline performance and a second line 404 that shows the predicted improvements over the baseline.

The above mentioned low complexity processes for data transmission makes use of an adaptive channel prediction algorithm disclosed in WO 2016/137365. The algorithm has with the following distinguishing features: 1) the parameters of the adaptive channel prediction model are continuous time; 2) the regression vector of the adaptive channel prediction model reflects the time varying actual sampling period, 3) the continuous time parameters of the adaptive channel prediction model are estimated on-line, typically with a new recursive least squares algorithm, and 4) a prediction of the channel (complex amplitude or power) is obtained by linear prediction, where the continuous time estimated parameter vector is multiplied with the regression vector that reflects the varying sampling period. The adaptive channel prediction algorithm is described below.

As descried in WO 2016/137365, the Doppler effect of the channel can be expressed in the frequency domain as a power spectrum, where the highest Doppler frequency corresponds to the speed of the UE. To model this spectrum the following continuous model can be used:

$$\begin{matrix}y ( t ) = \frac{1}{A ( p )} e ( t ) & ( 1 ) \\ A ( p ) = {p}^{n} + {a}_{1} {p}^{n - 1} + … + {a}_{n} & ( 2 ) \\ p y ( t ) = \frac{d y ( t )}{d t} & ( 3 )\end{matrix}$$

Here p denotes the differentiation operator and aᵢ, i=i, . . . n, are the continuous time parameters. y(t) denotes the output, either complex channel amplitude or power. A(p) is the spectral polynomial that defines the Doppler spectrum in (eq. 1).

The measurements are the channel output (e.g., the channel output is here defined to be either the real part of the complex channel, the imaginary part of the complex channel, or the power of the channel, i.e. the sum of the squared real and imaginary parts) at the uneven sampling instances, i.e.

y(t₀), y(t₀+k₁h), y(t₀+(k₁+k₂)h), . . . y(t) (4)

Here the fundamental sampling period is given by h, while k₁ and k₂ are integers that model the momentary sampling period.

The next step is to replace the differentiation operator of (eq. 1)-(eq. 3) with sequential approximations. Since the intention here is to obtain a low computational complexity, and since simulations have shown that an order of n=2 is sufficient, this approximation is illustrated for order 2. The extensions to higher orders follow the same method, and the invention should therefore not be limited to orders less than or equal to 2.

To begin, it holds that:

$$p y ( {t}_{0} ) \approx \frac{{q}^{{k}_{1}} - 1}{{k}_{1} h} y ( {t}_{0} ) = \frac{y ( {t}_{0} + {k}_{1} h ) - y ( {t}_{0} )}{{k}_{1} h} , \qquad ( 5 )$$

where the shift operator q shifts the time one fundamental sampling period h ahead in time. Proceeding in this way results in:

$$\begin{matrix}p y ( {t}_{0} + {k}_{1} h ) \approx \frac{{q}^{{k}_{2}} - 1}{{k}_{2} h} y ( {t}_{0} + {k}_{1} h ) = \frac{y ( {t}_{0} + ( {k}_{1} + {k}_{2} ) h ) - y ( {t}_{0} + {k}_{1} h )}{{k}_{2} h} & ( 6 ) \\ {p}^{2} ( y ( {t}_{0} ) ) = p ( p y ( {t}_{0} ) ) \approx \frac{{q}^{{k}_{1}} - 1}{{k}_{1} h} ( p y ( {t}_{0} ) ) \approx \\ \frac{p y ( {t}_{0} + {k}_{1} h ) - p y ( {t}_{0} )}{{k}_{1} h} \approx \frac{\frac{{q}^{{k}_{2}} - 1}{{k}_{2} h} {q}^{{k}_{1}} y ( {t}_{0} ) - \frac{{q}^{{k}_{1}} - 1}{{k}_{1} h} y ( {t}_{0} )}{{k}_{1} h} = \frac{1}{{h}^{2}} ( \frac{1}{{k}_{1} {k}_{2}} {q}^{{k}_{1} + {k}_{2}} - ( \frac{1}{{k}_{1} {k}_{2}} + \frac{1}{{k}_{1}^{2}} ) {q}^{{k}_{1}} + \frac{1}{{k}_{1}^{2}} ) y ( {t}_{0} ) & ( 7 )\end{matrix}$$

It can be noted that the choice k1=k2=1 results in the familiar three point approximation of the second derivative of a signal.

To obtain a discrete time model, from (eq. 1)-(eq. 3), the following approximations are introduced:

py(t)≈py(t₀) (8)

p²y(t)≈p²y(t₀) (9)

Employing (eq. 8) and (eq. 9) in (eq. 1), multiplying the filter equation by q^{k}^{₁}^{+k}^{₂}, and using the fact that in the case n=2 (eq. 4) implies q^{k}^{₁}^{+k}^{₂} y(t₀)=y(t), q^{k}^{₁}y(t₀)=q^{-k}^{₂}y(t), y(t₀)=^{-(k}^{₁}^{+k}^{₂}⁾y(t), then results in the filter equation:

$$y ( t ) = - {a}_{1} {k}_{2} h ( y ( t - {k}_{2} h ) - y ( t - ( {k}_{1} + {k}_{2} ) h ) ) - {a}_{2} {k}_{1} {k}_{2} {h}^{2} y ( t - ( {k}_{1} + {k}_{2} ) h ) + y ( t - {k}_{2} h ) + \frac{{k}_{2}}{{k}_{1}} ( y ( t - {k}_{2} h ) - y ( t - ( {k}_{1} + {k}_{2} ) h ) ) + {k}_{1} {k}_{2} {h}^{2} e ( t ) . \qquad ( 10 )$$

The final step in the derivation of the discrete time model is then to write (eq. 10) in linear regression form as:

$$\begin{matrix} y ( t ) = {φ}^{T} ( t ) θ + c ( t ) + v ( t ) & ( 11 ) \\ θ = ( \begin{matrix}{a}_{1} & {{a}_{2} )}^{T}\end{matrix} & ( 12 ) \\ φ ( t ) = {( - {k}_{2} h ( y ( t - {k}_{2} h ) - y ( t - ( {k}_{1} + {k}_{2} ) h ) ) - {k}_{1} {k}_{2} {h}^{2} y ( t - ( {k}_{1} + {k}_{2} ) h ) )}^{T} & ( 13 ) \\ c ( t ) = y ( t - {k}_{2} h ) + \frac{{k}_{2}}{{k}_{1}} ( y ( t - {k}_{2} h ) - y ( t - ( {k}_{1} + {k}_{2} ) h ) ) & ( 14 ) \\ v ( t ) = {k}_{1} {k}_{2} {h}^{2} e ( t ) & ( 15 )\end{matrix}$$

This equation is now directly suitable for prediction and on-line estimation. It can be noted that the estimation algorithm will include the prediction as one step.

Here the preferred embodiment using a so called recursive least squares algorithm will be presented. However, it should be noted that other alternatives exist and so the invention should not be limited to the use of the recursive least squares algorithm The recursive least squares algorithm follows from standard results in the literature of estimation. The result is:

$$\begin{matrix}K ( t ) = \frac{P ( t ) φ ( t )}{λ + {φ}^{T} ( t ) P ( t ) φ ( t )} & ( 16 ) \\ \hat{y} ( t ) = {φ}^{T} ( t ) \hat{θ} ( t - {k}_{2} h ) + c ( t ) & ( 17 ) \\ \hat{θ} ( t ) = \hat{θ} ( t - {k}_{2} h ) + K ( t ) ( y ( t ) - \hat{y} ( t ) ) & ( 18 ) \\ P ( t ) = \frac{( P ( t - {k}_{2} h ) - P ( t - {k}_{2} h ) φ ( t ) {φ}^{T} ( t ) P ( t - {k}_{2} h ) )}{λ ( λ + {φ}^{T} ( t ) P ( t - {k}_{2} h ) φ ( t ) )} & ( 19 )\end{matrix}$$

Above, (eq. 16) computes the update gain K(t) in terms of the covariance matrix P(t), the regression vector (eq. 13) and the forgetting factor λ. The channel prediction, ŷ(t), is then computed in (eq. 17) by vector multiplication of the estimated parameters \hat{θ}(t−k₂h) of the previous step, (eq. 13) and (eq. 14). Using the last measurement y(t) the new estimate is then updated in (eq. 18). Finally, the covariance matrix is updated in (eq. 19). This completes the description of the algorithm for adaptive channel prediction.

The Doppler spectrum varies with the frequency over the LTE band (frequency selective fading). This means that in case a UE is scheduled for high data rate transmission, then the UE will occupy a large part of the frequency band. The inventors have recognized that a process that uses only a single adaptive prediction instance is not capable of modeling and prediction of the Doppler spectrum variation over time, simply since it cannot capture the frequency selective fading in more than a narrow subset of sub-bands of the whole LTE spectral band. This also makes it impossible to do Doppler prediction supported link adaptation in the uplink for high data rate users. Furthermore, the inventors have recognized that it would be advantageous to do Doppler prediction supported link adaptation for the downlink.

Accordingly, it is proposed herein to use, for each WCD, a plurality of instances (i.e., a “bank” of instances”) of the above described adaptive channel prediction algorithm based on continuous time parameters with a corresponding recursive estimator, which automatically handles multiple and even varying sampling rates. The estimator produces the same parameter values, irrespective of the sampling rate applied, a fact that makes optimal prediction straightforward, for each sub-band of a user handled by one complex algorithm instance. In order to obtain Doppler prediction supported link adaptation for the downlink, the inventors disclose the use of the disclosed bank of instances for a single UE of the prediction algorithm for Doppler channel estimation in the uplink, followed by performing Doppler channel prediction for the time division duplex (TDD) channel in the downlink. The key idea is that for TDD deployments, the uplink and the downlink share the same frequency band. The reciprocity property of radio communication then secures that the channels (and hence the Doppler estimation and prediction properties) are the same. Also disclosed are ways of using the optimal predictions produced by the algorithm, to modify the signal used by the link adaptation, so that the link adaptation performs better. This, in turn improves the performance of the scheduler. The end result is an improved capacity, for the uplink and for TDD deployments also the downlink.

FIG. 5 further illustrates channel quality filter 291 according to some embodiments. As illustrated in FIG. 5, channel quality filter 291 includes a “bank” of channel predictors 502. As further illustrated in FIG. 5, channel estimates are provided by the UL physical layer (PHY) 290 (see FIG. 2). These estimates could be based on Sounding Reference Symbols (SRS) transmitted by WCD 102 to enable channel quality estimation in network node 112, but it could also be transmissions of user data or protocol feedback, e.g. RLC status PDUs or TCP ACKs. Each channel predictor 502 operates on channel estimates from a specific frequency sub-band of the channel. That is, each channel predictor 502 is assigned to a specific frequency sub-band.

As illustrated in FIG. 5, each channel predictor 502 has an associated channel estimate extractor (EE) 504 that receives the channel estimates from UL PHY 290 and provides to the associated channel predictor 502 only those channel estimates from the specific frequency sub-band for the channel predictor. For example, if predictor 502a is assigned to frequency sub-band 1, then extractor 504a provides to predictor 502a only the channel estimates for sub-band 1, similarly, if predictor 502b is assigned to frequency sub-band 2, then extractor 504b provides to predictor 502b only the channel estimates for sub-band 2, etc. In this context a frequency sub-band is a part of the uplink spectrum, e.g. 1 PRB or a group of PRBs.

In some embodiments, each channel predictor 502 operates in two phases. A first phase that is executed when new measurements are received, with the objective to update adaptive filter parameters, and a second phase (i.e., the prediction phase) in which a new channel prediction (e.g., a new channel gain prediction) is generated based on the updated adaptive filter parameters. That is, each channel predictor 502 uses a current channel estimate and one or more previous channel estimates to predict a channel gain. The predicated channel gains are provided to downlink adapter 292, which then uses the predicated channel gains to determine the optimal transmission parameters (MCS, Rank and Precoder). This could for example be done using an exhaustive search over the available ranks and precoders to find the combination that maximizes the throughput. In a preferred embodiment the channel updates and channel prediction is performed by each of the channel predictors 502 each implementing (eq. 16)-(eq. 19). The updates are performed using uplink channel quality estimates, while the predictions are used for example for downlink link adaptation.

FIG. 6 shows a plurality of uplink transmissions by WCD 102 over 14 sub-frames (i.e., over a time period of 14 milliseconds). As shown, in FIG. 6, the number of frequency sub-bands (rows in FIG. 6) allocated for each sub-frame transmission is not constant. For example, in subframe 1 WCD 102 was allocated 7 frequency sub-bands (i.e., bands 4-10), whereas in sub frames 4 and 5 WCD 102 was allocated all twelve sub-bands. The amount of frequency that is allocated to a UE depends on a number of factors, including the amount of data in the UE buffer (if the UE has a very limited amount of data in the buffer this will not require the full system bandwidth and the scheduler will allocate a smaller number of sub-bands). Additionally, the uplink scheduler will distribute bandwidth between active WCDs with data in the buffer. Hence, in some subframes (e.g., subframe 0), WCD 102 is not allocated any sub-bands.

As mentioned above, each channel predictor 502 is assigned to one or more sub-bands. For example, the channel predictor bank 502 may consists of twelve channel predictors and each channel predictor is assigned to one of the twelve sub-bands shown in FIG. 6. In such a scenario, as can be seen from FIG. 6, different channel predictors will receive new samples in different subframes. For example the channel predictor assigned to sub-band 4 will receive new samples in subframes 1, 4, 5, 8 and 9. Due to the multi-rate nature of the channel predictors, this non-uniform arrival of the samples can be handled in an elegant way.

FIG. 7 is a flow chart illustrating a process 700 according to some embodiments. Process 700 may begin in step s702 in which network node 112 instantiates a bank of channel predictors for WCD 102 (e.g., in step s702 network node 112 may instantiate a bank of channel predictors each WCD that network node 112 is currently serving).

In step s704, channel measurements are performed for all sub-bands where WCD 102 is scheduled in the uplink. These channel measurements (a.k.a., channel estimates) are provided to the instantiated channel predictors as described above.

In step s706, each of the instantiated channel predictors uses the channel estimates to produce and output a channel gain prediction. For example, in step s706, equations 16 to 19 are run for all sub-bands where WCD 102 is scheduled in the uplink, and equations 16, 17, and 19 are run for sub-bands where the user is not scheduled.

In step s708, network node 112 the predicted channel gains produced by the channel predictors based on the uplink transmissions are applied for link adaptation purposes in the downlink for all downlink sub-bands that are covered by the uplink sub-bands.

As the above illustrates, a bank of uplink channel predictors are applied for each user and the predicted channel is applied in the downlink, referring to reciprocity. These features enable the TDD DL throughput improvements described above. Moreover, as described above, the implementation complexity is low. For example, the computational complexity is quite low because the order of the estimated filter is only two. The memory requirements are of the order of 10 states per instance while the computational complexity for one update of one instance appears to be well below 50 arithmetic operations. At a sampling rate of 1 kHz and 100 instances (1 per resource block) this sums up to a computational complexity of less than 5 million arithmetic operations/s and a need for less than 1000 states. Interpolation and a less fine frequency division may reduce the number of states with about a factor of 5-10.

FIG. 8 is a flow chart illustrating a process 800, according to other embodiments, that is performed by network node 112 for link adaptation with respect to a channel 155 between network node 112 and WCD 102, wherein the channel is defined in continuous time and a sampling rate of the channel is non-uniform. Process 800 may begin with step s802, in which network node 112 receives: i) a first UL transmission from WCD 102 on a first UL sub-band of the channel (e.g., sub-band 4 shown FIG. 6) and ii) a second UL transmission from WCD 102 on a second UL sub-band of the channel (e.g., sub-band 5 shown FIG. 6), wherein the first and second UL transmissions are received at the same time (e.g., the UL transmission are in the same subframe, such as, for example, subframe 1 shown in FIG. 6).

In step s804, a first channel estimate based on the first UL transmission from WCD 102 on the first UL sub-band of the channel is provided to a first channel predictor.

In step s806, a second channel estimate based on the second UL transmission from WCD 102 on the second UL sub-band of the channel is provided to a second channel predictor.

In step s808, a first previous channel estimate is retrieved.

In step s810, a second previous channel estimate is retrieved.

In step s812, the first channel predictor uses the first channel estimate and the first previous channel estimate to predict a first channel gain.

In step s814, the second channel predictor uses the second channel estimate and the second previous channel estimate to predict a second channel gain.

In step s816, the first and second predicated channel gains, among other things, are used to perform a link adaptation for DL sub-bands corresponding to the first and second UL sub-bands.

In some embodiments, using the first channel estimate to predict the first channel gain comprises performing a first linear prediction in which a first continuous time estimated parameter vector is multiplied with a first regression vector obtained using a first sampling descriptor, k₁, and second sampling descriptor, k₂, and using the second channel estimate to predict the second channel gain comprises performing a second linear prediction in which a second continuous time estimated parameter vector is multiplied with a second regression vector obtained using k₁ and k₂. In some embodiments, the predicted first channel gain at time t, ŷ₁(t), is defined by: ŷ₁(t)=φ₁^{T}(t)\hat{θ}₁(t−k₂h)+c₁(t), wherein φ₁^{T}(t) is a first regression vector at time t, \hat{θ}₁(t−k₂h) is a channel estimate at a time taking k₂ into account, and c₁(t) is a parameter independent part of the prediction.

In some embodiments, the predicted second channel gain at time t, ŷ₂(t), is defined by: ŷ₂(t)=φ₂^{T}(t)\hat{θ}₂(t−k₂h)+c₂(t), wherein φ₂^{T}(t) is a second regression vector at time t, \hat{θ}₂(t−k₂h) is a channel estimate at a time taking k₂ into account, and c₂(t) is a parameter independent part of the prediction.

FIG. 9 is a block diagram of network node 112 according to some embodiments. As shown in FIG. 9, network node 112 may comprise: a data processing apparatus (DPA) 902, which may include one or more processors (P) 955 (e.g., a general purpose microprocessor and/or one or more other processors, such as an application specific integrated circuit (ASIC), field-programmable gate arrays (FPGAs), and the like); a network interface 948 comprising a transmitter (Tx) 945 and a receiver (Rx) 947 for enabling the network node to transmit data to and receive data from other nodes connected to a network 110 (e.g., an Internet Protocol (IP) network) to which network interface 948 is connected; circuitry 903 (e.g., radio transceiver circuitry) coupled to an antenna system 904 for wireless communication with WCDs); and local storage unit (a.k.a., “data storage system”) 908, which may include one or more non-volatile storage devices and/or one or more volatile storage devices (e.g., random access memory (RAM)). In embodiments where DPA 902 includes a general purpose microprocessor, a computer program product (CPP) 941 may be provided. CPP 941 includes a computer readable medium (CRM) 942 storing a computer program (CP) 943 comprising computer readable instructions (CRI) 944. CRM 942 may be a non-transitory computer readable medium, such as, but not limited, to magnetic media (e.g., a hard disk), optical media, memory devices (e.g., random access memory), and the like. In some embodiments, the CRI 944 of computer program 943 is configured such that when executed by data processing apparatus 902, the CRI causes network node 112 to perform steps described herein (e.g., steps described herein with reference to the flow charts and/or message flow diagrams). In other embodiments, network node 112 may be configured to perform steps described herein without the need for code. That is, for example, DPA 902 may consist merely of one or more ASICs. Hence, the features of the embodiments described herein may be implemented in hardware and/or software.

FIG. 10 is a diagram showing functional modules of network node 112 according to some embodiments. As shown in FIG. 10, the network node 112 includes: a UL receiving module 1002 for employing circuitry 903 to receive: i) a first UL transmission from the WCD on a first UL sub-band of the channel and ii) a second UL transmission from the WCD on a second UL sub-band of the channel, wherein the first and second UL transmissions are received at the same time; a channel predictor module 1004; a channel estimate providing module 1006 configured to provide to the channel predictor module i) a first channel estimate based on the first UL transmission from the WCD on the first UL sub-band of the channel and ii) a second channel estimate based on the second UL transmission from the WCD on the second UL sub-band of the channel; a channel estimate retrieving module 1008 configured to retrieve i) a first previous channel estimate and ii) a second previous channel estimate; and a link adaptation module 1010. The channel predictor module 1004 is configured to: i) use the first channel estimate and the first previous channel estimate to predict a first channel gain and ii) use the second channel estimate and the second previous channel estimate to predict a second channel gain. The link adaptation module 1010 is configured to use the first and second predicated channel gains to perform a link adaptation for DL sub-bands corresponding to the first and second UL sub-bands.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a network node of a radio access network for link adaptation with respect to a channel between a wireless communication device (WCD) and the network node, wherein the channel is defined in continuous time and a sampling rate of the channel is non-uniform, the method comprising:
receiving i) a first uplink (UL) transmission from the WCD on a first UL sub-band of the channel and ii) a second UL transmission from the WCD on a second UL sub-band of the channel, wherein the first and second UL transmissions are received at the same time;
providing to a first channel predictor a first channel estimate based on the first UL transmission from the WCD on the first UL sub-band of the channel;
providing to a second channel predictor a second channel estimate based on the second UL transmission from the WCD on the second UL sub-band of the channel;
retrieving a first previous channel estimate;
retrieving a second previous channel estimate;
the first channel predictor using the first channel estimate and the first previous channel estimate to predict a first channel gain;
the second channel predictor using the second channel estimate and the second previous channel estimate to predict a second channel gain; and
using the first and second predicated channel gains, performing a link adaptation for downlink (DL) sub-bands corresponding to the first and second UL sub-bands.

2. The method of claim 1, wherein:
using the first channel estimate to predict the first channel gain comprises performing a first linear prediction in which a first continuous time estimated parameter vector is multiplied with a first regression vector obtained using a first sampling descriptor, k₁, and second sampling descriptor, k₂, and
using the second channel estimate to predict the second channel gain comprises performing a second linear prediction in which a second continuous time estimated parameter vector is multiplied with a second regression vector obtained using k₁ and k₂.

3. The method of the claim 2, wherein the predicted first channel gain at time t, ŷ₁(t), is defined by:
ŷ₁(t)=φ₁^{T}(t)\hat{θ}₁(t−k₂h)+c₁(t), wherein
φ₁^{T}(t) is a first regression vector at time t,
\hat{θ}₁(t−k₂h) is a channel estimate at a time taking k₂ into account, and
c₁(t) is a parameter independent part of the prediction.

4. The method of claim 3, wherein the predicted second channel gain at time t, ŷ₂(t), is defined by:
ŷ₂(t)=φ₂^{T}(t)\hat{θ}₂(t−k₂h)+c₂(t), wherein
φ₂^{T}(t) is a second regression vector at time t,
\hat{θ}₂(t−k₂h) is a channel estimate at a time taking k₂ into account, and
c₂(t) is a parameter independent part of the prediction.

5. A computer program product comprising a non-transitory computer readable medium storing a computer program comprising instructions which, when executed on at least one processor, causes the at least one processor to carry out the method of claim 1.

6. The computer program product of claim 5, wherein the computer program further comprises instructions which, when executed on the at least one processor, causes the at least one processor to perform the steps of:
using the first channel estimate to predict the first channel gain comprises performing a first linear prediction in which a first continuous time estimated parameter vector is multiplied with a first regression vector obtained using a first sampling descriptor, k₁, and second sampling descriptor, k₂, and
using the second channel estimate to predict the second channel gain comprises performing a second linear prediction in which a second continuous time estimated parameter vector is multiplied with a second regression vector obtained using k₁ and k₂.

7. A network node for link adaptation with respect to a channel between a wireless communication device (WCD) and the network node, wherein the channel is defined in continuous time and a sampling rate of the channel is non-uniform, the network node comprising:
an uplink (UL) receiving module for employing circuitry to receive: i) a first UL transmission from the WCD on a first UL sub-band of the channel and ii) a second UL transmission from the WCD on a second UL sub-band of the channel, wherein the first and second UL transmissions are received at the same time;
a channel predictor module;
a channel estimate providing module configured to provide to the channel predictor module i) a first channel estimate based on the first UL transmission from the WCD on the first UL sub-band of the channel and ii) a second channel estimate based on the second UL transmission from the WCD on the second UL sub-band of the channel;
a channel estimate retrieving module configured to retrieve i) a first previous channel estimate and ii) a second previous channel estimate; and
a link adaptation module, wherein
the channel predictor module is configured to: i) use the first channel estimate and the first previous channel estimate to predict a first channel gain and ii) use the second channel estimate and the second previous channel estimate to predict a second channel gain, and
the link adaptation module is configured to use the first and second predicated channel gains to perform a link adaptation for downlink (DL) sub-bands corresponding to the first and second UL sub-bands.

8. A network node of a radio access network operable to perform link adaptation with respect to a channel between a wireless communication device (WCD) and the network node, wherein the channel is defined in continuous time and a sampling rate of the channel is non-uniform, the network node being adapted to:
receive i) a first uplink (UL) transmission from the WCD on a first UL sub-band of the channel and ii) a second UL transmission from the WCD on a second UL sub-band of the channel, wherein the first and second UL transmissions are received at the same time;
provide to a first channel predictor a first channel estimate based on the first UL transmission from the WCD on the first UL sub-band of the channel;
provide to a second channel predictor a second channel estimate based on the second UL transmission from the WCD on the second UL sub-band of the channel;
retrieve a first previous channel estimate;
retrieve a second previous channel estimate;
employ the first channel predictor to use the first channel estimate and the first previous channel estimate to predict a first channel gain;
employ the second channel predictor to use the second channel estimate and the second previous channel estimate to predict a second channel gain; and
use the first and second predicated channel gains, performing a link adaptation for downlink (DL) sub-bands corresponding to the first and second UL sub-bands.

9. A network node of a radio access network operable to perform link adaptation with respect to a channel between a wireless communication device (WCD) and the network node, wherein the channel is defined in continuous time and a sampling rate of the channel is non-uniform, the network node comprising:
a local storage unit;
a data processing apparatus comprising one or more processors, wherein the data process apparatus is coupled to the local storage unit and is configured to:
employ a receiver to receive i) a first uplink (UL) transmission from the WCD on a first UL sub-band of the channel and ii) a second UL transmission from the WCD on a second UL sub-band of the channel, wherein the first and second UL transmissions are received at the same time;
provide to a first channel predictor a first channel estimate based on the first UL transmission from the WCD on the first UL sub-band of the channel;
provide to a second channel predictor a second channel estimate based on the second UL transmission from the WCD on the second UL sub-band of the channel;
retrieve a first previous channel estimate;
retrieve a second previous channel estimate;
employ the first channel predictor to use the first channel estimate and the first previous channel estimate to predict a first channel gain;
employ the second channel predictor to use the second channel estimate and the second previous channel estimate to predict a second channel gain; and
use the first and second predicated channel gains, performing a link adaptation for downlink (DL) sub-bands corresponding to the first and second UL sub-bands.

10. The network node of claim 9, wherein:
using the first channel estimate to predict the first channel gain comprises performing a first linear prediction in which a first continuous time estimated parameter vector is multiplied with a first regression vector obtained using a first sampling descriptor, k₁, and second sampling descriptor, k₂, and
using the second channel estimate to predict the second channel gain comprises performing a second linear prediction in which a second continuous time estimated parameter vector is multiplied with a second regression vector obtained using k₁ and k₂.

11. The network node of the claim 10, wherein the predicted first channel gain at time t, ŷ₁(t), is defined by:
ŷ₁(t)=φ₁^{T}(t)\hat{θ}₁(t−k₂h)+c₁(t), wherein
φ₁^{T}(t) is a first regression vector at time t,
\hat{θ}₁(t−k₂h) is a channel estimate at a time taking k₂ into account, and
c₁(t) is a parameter independent part of the prediction.

12. The network node of claim 11, wherein the predicted second channel gain at time t, ŷ₂(t), is defined by:
ŷ₂(t)=φ₂^{T}(t)\hat{θ}₂(t−k₂h)+c₂(t), wherein
φ₂^{T}(t) is a second regression vector at time t,
\hat{θ}₂(t−k₂h) is a channel estimate at a time taking k₂ into account, and
c₂(t) is a parameter independent part of the prediction.
